(19) United States
(12) Patent Application Publication
(10) Pub. No.: US 2026/0030629 A1
(43) Pub. Date: Jan. 29, 2026

(54) METHODS AND APPARATUS FOR ONE-TIME PASSWORD DETECTION AND ALERT

(71) Applicant: Intel Corporation, Santa Clara, CA (US)

(72) Inventors: Vaibhavdeep Singh, Chandigarh (IN); Hemant Sathish, Bangalore (IN); Rohit Sundaram, Bangalore (IN); Anjali Praveen, Bangalore (IN)

(73) Assignee: Intel Corporation, Santa Clara, CA (US)

(21) Appl. No.: 19/350,215

(22) Filed: Oct. 6, 2025

Related U.S. Application Data
(63) Continuation of application No. 18/618,610, filed on Mar. 27, 2024.

(51) Int. Cl. G06Q 20/40

(52) U.S. Cl. CPC G06Q 20/4014

(57) ABSTRACT

Methods and apparatus for one-time password detection and alert are disclosed. A disclosed example apparatus includes machine readable instructions, and at least one processor circuit to be programmed by the machine readable instructions to classify, with a trained machine-learning model, messages of a messaging platform of a computing device as one of a financial transaction or a non-financial transaction, and provide a warning based on a one-time password (OTP) message of the messages being classified as a financial transaction.

### CLAIM TO PRIORITY

This application is a continuation of and claims the benefit of and priority to U.S. application Ser. No. 18/618,610, entitled METHODS AND APPARATUS FOR ONE-TIME PASSWORD DETECTION AND ALERT, by Vaibhavdeep Singh, et al., filed Mar. 27, 2024, the entire contents of which are incorporated herein by reference.

### FIELD OF THE DISCLOSURE

This disclosure relates generally to messaging alert mechanisms and, more particularly, to methods and apparatus for one-time password detection and alert.

### BACKGROUND

One-time passwords (OTPs) have become an integral part of secure transactions. In particular, OTPs are sent with a message (e.g., a text message received at a portable computing device) and act as a unique password that can be used for logging on to a service or network. The password is typically provided as a series of characters including letters or numbers, such as pin code.

### BRIEF DESCRIPTION OF THE DRAWINGS

FIG. 1 is a block diagram of an example message warning system in accordance with teachings of this disclosure.

FIG. 2 is a block diagram of an example implementation of the example message warning system of FIG. 1.

FIGS. 3 and 4 are flowcharts representative of example machine readable instructions and/or example operations that may be executed, instantiated, and/or performed by example programmable circuitry to implement the message warning system of FIG. 2.

FIG. 5 is a block diagram of an example processing platform including programmable circuitry structured to execute, instantiate, and/or perform the example machine readable instructions and/or perform the example operations of FIGS. 3 and 4 to implement the message warning system of FIG. 2.

FIG. 6 is a block diagram of an example implementation of the programmable circuitry of FIG. 5.

FIG. 7 is a block diagram of another example implementation of the programmable circuitry of FIG. 5.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Methods and apparatus for one-time password detection and alerts are disclosed. One-time passwords (OTPs) (also known as one-time personal identification number (PIN), one time authorization code (OTAC), or dynamic password) are non-static passwords utilized for authentication. OTP are frequently valid for a temporary period (e.g., 1 minute, 30 minutes, etc.) and/or are frequently valid for a single login session (e.g., a new OTP is utilized for each new login attempt, login session, etc.). OTP are frequently utilized to enable access to a network, a service, a computer system, a transaction, etc.

Bad actors can attempt to utilize OTP messages for fraudulent purposes by which a user is deceived into providing credentials to a third party such that the third party can get authorization (e.g., authorize a financial transaction (e.g., a bank transfer action)) while believing that they are providing the credentials for another reason. In particular, the user may not be able to discern a financial and/or bank OTP message and, thus, they can accidentally divulge a financial transaction authorization, which in many cases is not initiated by the user. Some recent fraudulent activity can be related to the unregulated nature of OTPs, which may vary based on practices of a company or a bank. Generally, a lack of knowledge of protecting OTPs and pin codes can result a user unknowingly sharing an OTP that authorizes a monetary transaction

In a specific example of OTP fraud, a fraudster approaches a house and/or location of a person and states that they have a package delivery, which is a false pretense. In turn, the fraudster asks the person to share an OTP they received through a text message if they want to cancel the delivery. The OTP requested is sometimes a pin-code to approve a bank transaction, such as a transfer of funds from a bank account of the person. Due to the person being unaware that the pin they are sharing is actually for a financial transaction, monetary losses can result. Non-standard and non-uniform content of OTP messages can also exacerbate this situation.

Examples disclosed herein utilize artificial intelligence (AI)/machine learning (ML) to label a message as one of a financial transaction message or a non-financial transaction message. As a result, a user can be more cautious with respect to fraudulent messages. Examples disclosed herein utilize a trained machine-learning model to determine if the message includes an OTP associated with a financial transaction or a non-financial transaction via the trained machine-learning model. According to examples disclosed herein, the context of the message is extracted through natural language processing techniques before passing onto transformer models. In turn, a warning is provided based on the message having an OTP classified and/or flagged as a financial transaction.

In some examples, the message with the OTP is classified and/or labeled as one of a bank transaction or not being a bank transaction. In some examples, the message is highlighted with a color, border, etc. or other indicia in response to having an OTP that corresponds to a financial transaction. In some examples, the message is flagged. In some examples, a banner indication is provided as a warning if the message is classified as including an OTP corresponding to a financial transaction. In some examples, a portable device (e.g., a portable computing device) is provided with an indication of whether a message has an OTP that is associated with a financial transaction.

As used herein, the term “financial transaction” corresponds to a transaction that involves a transfer of funds and/or a change to a financial account/status/account setting. As used herein, the term “one-time password” refers to a password, pin or other credential sent to a user to verify an identify thereof. As used herein, the term “portable device” refers to a portable computing device such as, but not limited to, a mobile phone, a tablet, a laptop, etc.

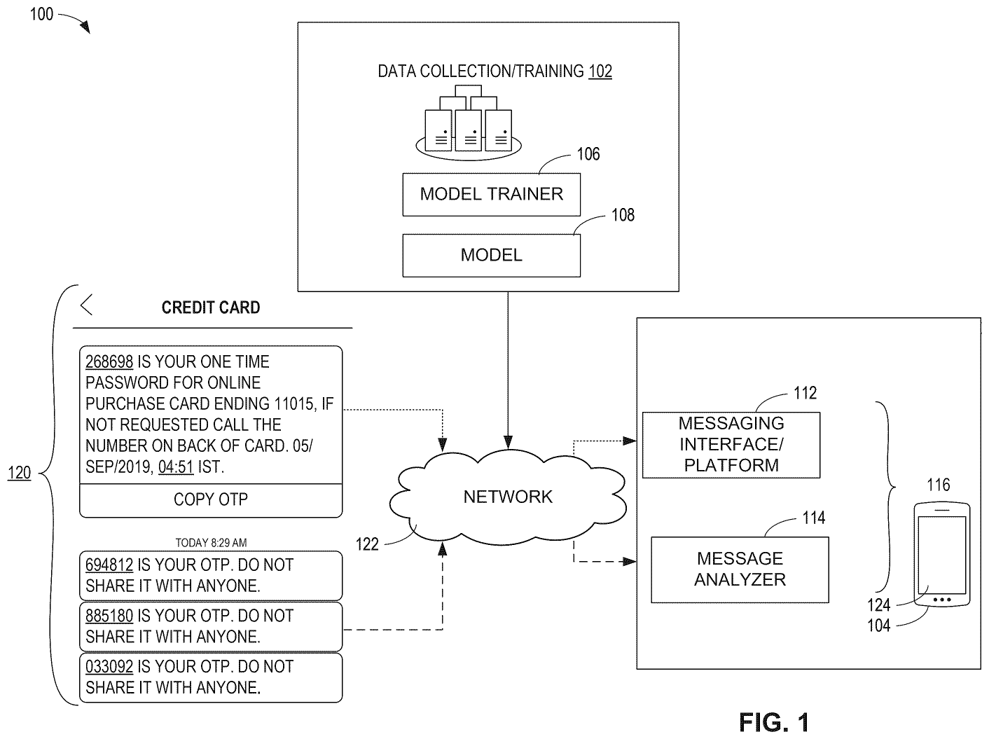

FIG. 1 is a block diagram of an example message warning system 100 in accordance with teachings of this disclosure. The message warning system 100 of the illustrated example includes a data collection/training system 102, and a computing device (e.g., a portable computing device, a mobile device, a phone, a tablet, a computer, etc.) 104. In turn, the example data collection/training system 102 includes a model trainer 106 that is utilized to train and/or maintain an ML model 108. In this example, the computing device 104 includes a messaging interface/platform 112, and a message analyzer 114. The computing device 104 can utilize an application 116 that includes or interfaces with the messaging interface/platform 112 and/or the message analyzer 114.

In operation, messages 120 are received at a network 122 and relayed to the computing device 104 via the messaging platform 112. Accordingly, the messages 120 are conveyed at a display 124 of the computing device 104. In this example, the messages 120 are not sent to the data collection/training system 102. As can be seen in FIG. 1, the messages 120 can be financial related (e.g., bank, credit card, investment brokerage, etc.). Further, the messages 120 can include OTP messages that do not include certain information such as a source of a message while other OTP messages can include information as to the source of the message and/or instructions/guidance on how to proceed.

To provide an indication and/or warning to a user of the computing device 104 via the display 124, the computing device 104 utilizes the model 108 provided from the data collection/training system 102 via the network 122. In particular, the model 108 is trained with aggregated messages (e.g., messages aggregated from multiple computing devices) and sources of the messages in a training phase thereof. In an inference phase, the trained model 108 is utilized for analysis of the messages received at the computing device 104. In this example, the trained model is utilized to label and/or identify messages that are financial transactions.

To train the machine-learning model 108, the example model trainer 106 is implemented to generate the model 108 with messages and labels thereof. The labels can correspond to financial/non-financial transactions, spam messages, whether the message is an OTP message or not, language/text of the messages, context, etc. In this example the data collection/training system 102 provides and/or forwards the trained model 108 to the computing device 104, thereby enabling the computing device 104 to utilize the trained model 108 in an inference phase. As a result, the computing device 104 can discern financial verses non-financial OTP messages, for example.

Examples disclosed herein leverage AI with a dataset that is based on messages. In this example, a first operation is to collate a dataset with numerous types of messages, such as short message service (SMS) messages, for example. The messages can include messages with OTPs from banks regarding financial/bank transactions, spam messages containing OTPs, messages with different types of authentication purposes, etc. In some examples, the messages are labelled as either “Transaction” or “Non Transaction.” In other words, a binary classification can be utilized.

To address data security for the users, a federated learning approach can be used. For example, a global pre-trained model can be distributed to end user devices, and can be fine-tuned locally. In particular, to avoid sending and/or distribution of private data, the fine-tuned models are provided back that can later be aggregated into a single model which is, in turn, distributed and/or re-distributed to the end user devices. In some such examples, parameters (e.g., hyperparameters) are provided from the end user devices for adjustment of the model.

Since datasets for development primarily deal with messages, which can be regarded to be a language in essence, Natural Language Processing (NLP) techniques (e.g., lemmatization, tokenization etc.) may be incorporated to preprocess with an nltk library. According to examples disclosed herein, Bag of Words model or Term Frequency-Inverse Document Frequency (TF-IDF) can be utilized. As a result, major keywords utilized by adverse parties or fraudsters can be identified in their messages as compared to the legitimate ones.

According to examples disclosed herein, since text data is involved with the messages, transformers can be useful in understanding a context of a message. Transformers can be implemented in examples disclosed herein to understand the context using the model with use of an attention mechanism to highlight the appropriate features in the input.

In some examples, a transformer library from Hugging Face can be utilized to develop the model. The library offers usage of an XLNet transformer that performs efficiently for text classification use cases. Fine tuning may be accomplished while setting up the transformer using the library. XLNet can also be efficiently utilized in examples disclosed herein as every output element is connected to every input element. The library can predict the next word (“n+1”) in the sentence by training on the first “n” tokens. The prediction is then compared with the true word to internally tune the model. According to examples disclosed herein, the model can then be used for text classification purposes. Because XLNet was trained with a relatively larger amount of data and can understand the context of a sequence better by traversing through the data in both directions, its accuracy tends to be greater than that of other transformers.

The example architecture described and shown in connection with FIG. 1 is only an example and aspects described herein could be shared, combined and/or shifted between different components/systems. In other words, any other type of data/network topology can be implemented instead. For example, the model 108 may be at least partially trained at the computing device 104. Alternatively, the data collection/training system 102 may issue warnings, information and/or indications concerning ones of the messages 120 determined and/or classified to have an OTP corresponding to a financial/bank transaction to the computing device 104.

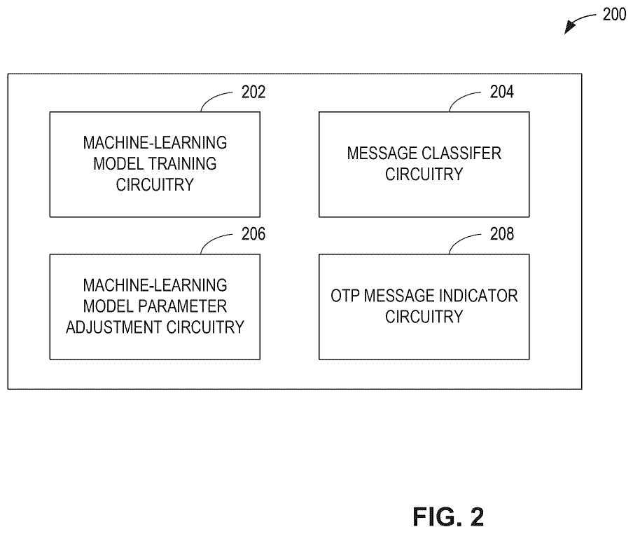

FIG. 2 is a block diagram of an example implementation of the example message warning system 200 to provide financial transaction warnings to a user of a computing device by utilizing a trained machine-learning model. The example message warning system 200 can be implemented in the computing device 104 and/or the data collection/training system 102. The message warning system 200 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the message warning system 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example message warning system 200 includes example machine-learning model training circuitry 202, example message classifier circuitry 204, example machine-learning model parameter adjustment circuitry 206, and example OTP message indicator circuitry 208.

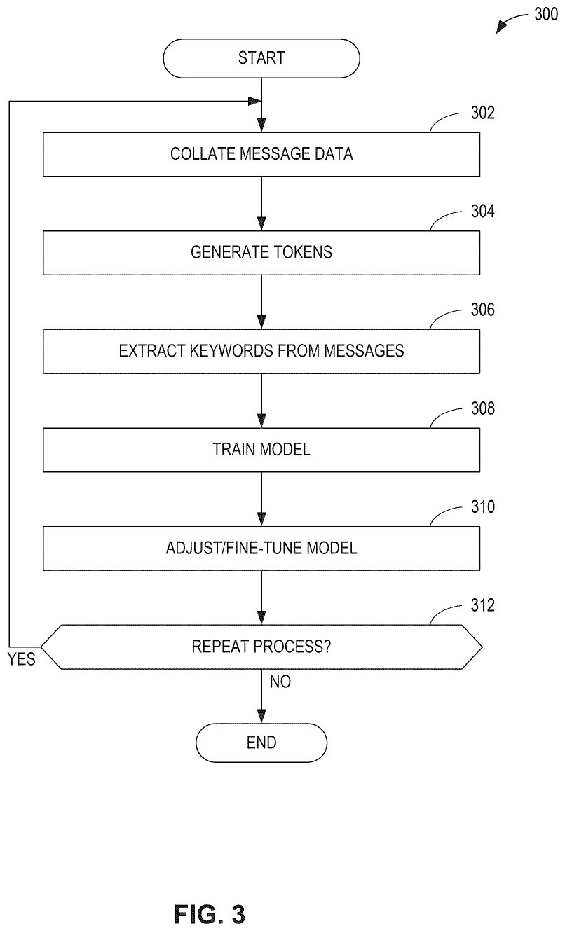

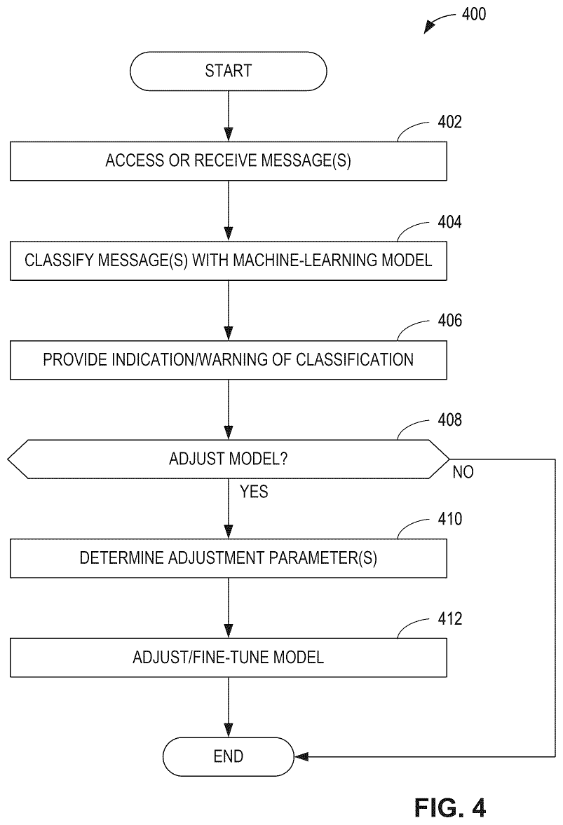

The example machine-learning model training circuitry 202 is implemented to train and/or develop a machine-learning model. The machine-learning model training circuitry 202 of the illustrated example can utilize messages including text with labels, such as “financial” or “non-financial.” In some examples, the machine-learning model training circuitry 202 is instantiated by programmable circuitry executing machine-learning model training instructions and/or configured to perform operations such as those represented by the flowcharts of FIGS. 3 and 4.

The example message classifier circuitry 204 is implemented to classify and/or identify a message of a messaging platform of a user device as having an OTP corresponding to one of a financial transaction or a non-financial transaction with the trained machine-learning model. In this example, the classification and/or the identification is performed at the user device. In some examples, the message classifier circuitry 204 is instantiated by programmable circuitry executing message classifier instructions and/or configured to perform operations such as those represented by the flowcharts of FIGS. 3 and 4.

In this example, the machine-learning model parameter adjustment circuitry 206 is implemented to adjust and/or fine-tune the model. In some examples, parameter and/or parameter data (e.g., hyperparameters) from different user devices is aggregated to fine-tune the model. In some examples, hyperparameters from user devices are aggregated. Accordingly, the fine-tuned model can then be redistributed to the user devices. In some examples, the machine-learning model parameter adjustment circuitry 206 is instantiated by programmable circuitry executing machine-learning model parameter adjustment instructions and/or configured to perform operations such as those represented by the flowcharts of FIGS. 3 and 4.

According to examples disclosed herein, the OTP message indicator circuitry 208 is implemented to provide a warning with respect to a message having an OTP that has been identified and/or classified to be associated with a financial transaction. In some examples, the OTP message indicator circuitry 208 is instantiated by programmable circuitry executing OTP message indicator instructions and/or configured to perform operations such as those represented by the flowcharts of FIGS. 3 and 4.

While an example manner of implementing the message warning system 200 of FIG. 2 is illustrated in FIG. 2, one or more of the elements, processes, and/or devices illustrated in FIG. 2 may be combined, divided, re-arranged, omitted, eliminated, and/or implemented in any other way. Further, the example machine-learning model training circuitry 202, the example message classifier circuitry 204, the example machine-learning model parameter adjustment circuitry 206, the example OTP message indicator circuitry 208, and/or, more generally, the example message warning system 200 of FIG. 2, may be implemented by hardware alone or by hardware in combination with software and/or firmware. Thus, for example, any of the example machine-learning model training circuitry 202, the example message classifier circuitry 204, the example machine-learning model parameter adjustment circuitry 206, the example OTP message indicator circuitry 208, and/or, more generally, the example message warning system 200, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example message warning system 200 of FIG. 2 may include one or more elements, processes, and/or devices in addition to, or instead of, those illustrated in FIG. 2, and/or may include more than one of any or all of the illustrated elements, processes and devices.

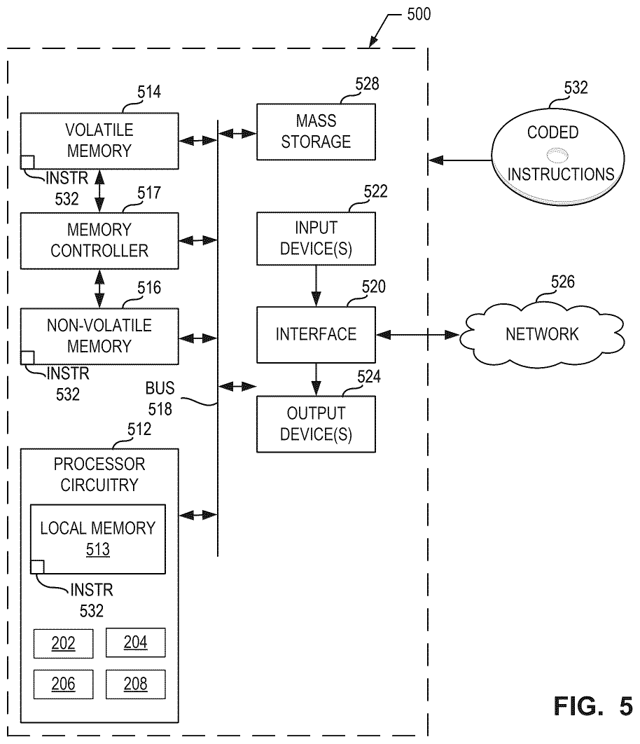

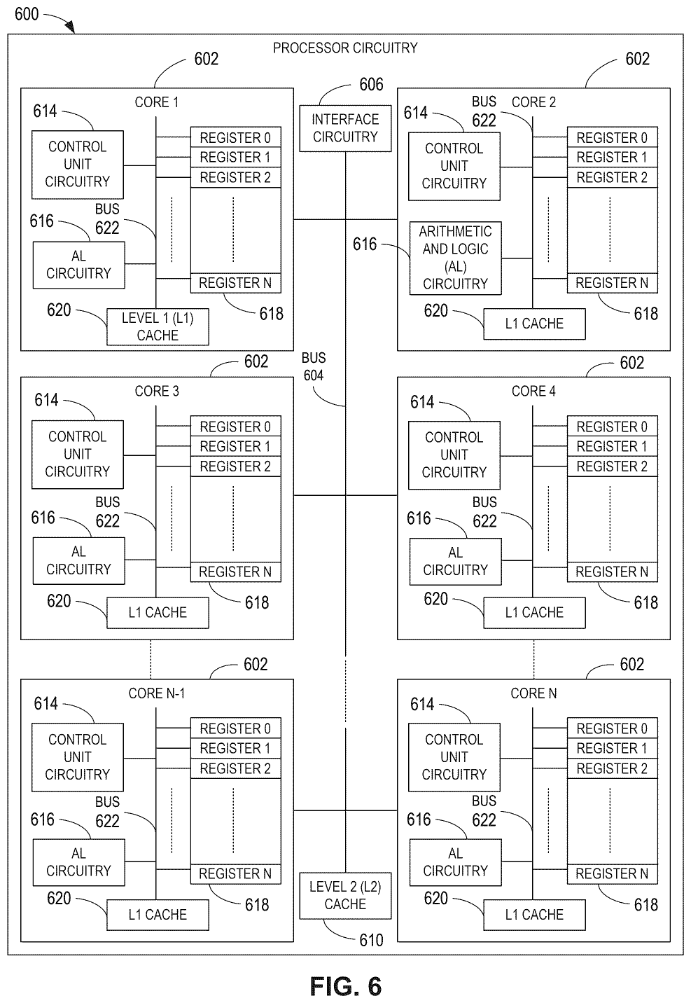

Flowcharts representative of example machine readable instructions, which may be executed by programmable circuitry to implement and/or instantiate the message warning system 200 of FIG. 2 and/or representative of example operations which may be performed by programmable circuitry to implement and/or instantiate the message warning system 200 of FIG. 2, are shown in FIGS. 3 and 4. The machine readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA) discussed below in connection with FIGS. 6 and/or 7. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 3 and 4, many other methods of implementing the example message warning system 200 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3 and 4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to train and/or develop machine-learning model for classification of messages. The example machine-readable instructions and/or the example operations 300 of FIG. 3 begin at block 302, at which the machine-learning model training circuitry 202 collates message data.

At block 304, the example machine-learning model training circuitry 202 generates tokens.

At block 306, the example machine-learning model training circuitry 202 extracts keywords from messages

At block 308, the example machine-learning model training circuitry 202 trains the machine-learning model.

At block 310, the example machine-learning model training circuitry 202 and/or the example machine-learning model parameter adjustment circuitry 206 adjusts/fine-tunes the machine-learning model.

At block 312, it is determined whether to repeat the process. If the process is to be repeated, control of the process returns to block 302. Otherwise, the process ends.

FIG. 4 is a flowchart representative of example machine readable instructions and/or example operations 400 that may be executed, instantiated, and/or performed by programmable circuitry to train. The example machine-readable instructions and/or the example operations 400 of FIG. 4 begin at block 402, at which the example message classifier circuitry 204 accesses or receives messages.

At block 404, the example message classifier circuitry 204 classifies messages with the trained machine-learning model. In this example, the messages (e.g., OTP messages of the messages) are classified as “financial transaction” or “non-financial transaction.”

At block 406, the OTP message indicator circuitry 208 provides a message/warning of the classification.

At block 408, it is determined by the example machine-learning model parameter adjustment circuitry 206 as to whether to adjust the model. If the model is to be adjusted (block 408), control of the process proceeds to block 410. Otherwise, the process ends.

At block 410, the example machine-learning model parameter adjustment circuitry 206 determines adjustment parameter(s).

At block 412, the example machine-learning model parameter adjustment circuitry 206 fine-tunes the model and the process ends.

FIG. 5 is a block diagram of an example programmable circuitry platform 500 structured to execute and/or instantiate the example machine-readable instructions and/or the example operations of FIGS. 3 and 4 to implement the message warning system 200 of FIG. 2. The programmable circuitry platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, DSPs, and/or microcontrollers from any desired family or manufacturer. The programmable circuitry 512 may be implemented by one or more semiconductor based (e.g., silicon based) devices. In this example, the programmable circuitry 512 implements the example machine-learning model training circuitry 202, the example message classifier circuitry 204, the example machine-learning model parameter adjustment circuitry 206, and the example OTP message indicator circuitry 208.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 532, which may be implemented by the machine readable instructions of FIGS. 3 and 4, may be stored in the mass storage device 528, in the volatile memory 514, in the non-volatile memory 516, and/or on at least one non-transitory computer readable storage medium such as a CD or DVD which may be removable.

FIG. 6 is a block diagram of an example implementation of the programmable circuitry 512 of FIG. 5. In this example, the programmable circuitry 512 of FIG. 5 is implemented by a microprocessor 600. For example, the microprocessor 600 may be a general-purpose microprocessor (e.g., general-purpose microprocessor circuitry). The microprocessor 600 executes some or all of the machine-readable instructions of the flowcharts of FIGS. 3 and 4 to effectively instantiate the circuitry of FIG. 2 as logic circuits to perform operations corresponding to those machine readable instructions. In some such examples, the circuitry of FIG. 2 is instantiated by the hardware circuits of the microprocessor 600 in combination with the machine-readable instructions. For example, the microprocessor 600 may be implemented by multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowcharts of FIGS. 3 and 4.

The cores 602 may communicate by a first example bus 604. In some examples, the first bus 604 may be implemented by a communication bus to effectuate communication associated with one(s) of the cores 602. For example, the first bus 604 may be implemented by at least one of an Inter-Integrated Circuit (I2C) bus, a Serial Peripheral Interface (SPI) bus, a PCI bus, or a PCIe bus. Additionally or alternatively, the first bus 604 may be implemented by any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the local memory 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating-point operations. In yet other examples, the AL circuitry 616 may include first AL circuitry that performs integer-based operations and second AL circuitry that performs floating-point operations. In some examples, the AL circuitry 616 may be referred to as an Arithmetic Logic Unit (ALU).

The registers 618 are semiconductor-based structures to store data and/or instructions such as results of one or more of the operations performed by the AL circuitry 616 of the corresponding core 602. For example, the registers 618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure, such as by being distributed throughout the core 602 to shorten access time. The second bus 622 may be implemented by at least one of an I2C bus, a SPI bus, a PCI bus, or a PCIe bus.

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages.

The microprocessor 600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 600, in the same chip package as the microprocessor 600 and/or in one or more separate packages from the microprocessor 600.

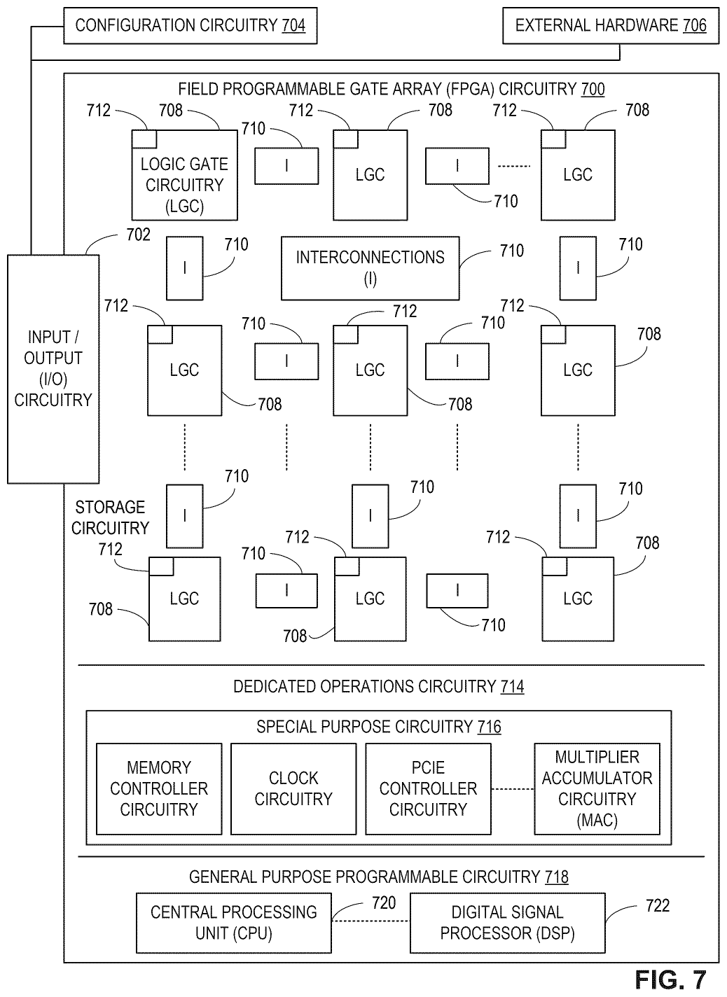

FIG. 7 is a block diagram of another example implementation of the programmable circuitry 512 of FIG. 5. In this example, the programmable circuitry 512 is implemented by FPGA circuitry 700. For example, the FPGA circuitry 700 may be implemented by an FPGA. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 600 of FIG. 6 described above (which is a general purpose device that may be programmed to execute some or all of the machine readable instructions represented by the flowchart(s) of FIGS. 3 and 4 but whose interconnections and logic circuitry are fixed once fabricated), the FPGA circuitry 700 of the example of FIG. 7 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3 and 4. In particular, the FPGA circuitry 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3 and 4. As such, the FPGA circuitry 700 may be configured and/or structured to effectively instantiate some or all of the operations/functions corresponding to the machine readable instructions of the flowchart(s) of FIGS. 3 and 4 as dedicated logic circuits to perform the operations/functions corresponding to those software instructions in a dedicated manner analogous to an ASIC. Therefore, the FPGA circuitry 700 may perform the operations/functions corresponding to the some or all of the machine readable instructions of FIGS. 3 and 4 faster than the general-purpose microprocessor can execute the same.

In the example of FIG. 7, the FPGA circuitry 700 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

The FPGA circuitry 700 of FIG. 7, includes example input/output (I/O) circuitry 702 to obtain and/or output data to/from example configuration circuitry 704 and/or external hardware 706. For example, the configuration circuitry 704 may be implemented by interface circuitry that may obtain a binary file, which may be implemented by a bit stream, data, and/or machine-readable instructions, to configure the FPGA circuitry 700, or portion(s) thereof. In some such examples, the configuration circuitry 704 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 706 may be implemented by external hardware circuitry. For example, the external hardware 706 may be implemented by the microprocessor 600 of FIG. 6.

The FPGA circuitry 700 also includes an array of example logic gate circuitry 708, a plurality of example configurable interconnections 710, and example storage circuitry 712. The logic gate circuitry 708 and the configurable interconnections 710 are configurable to instantiate one or more operations/functions that may correspond to at least some of the machine readable instructions of FIGS. 3 and 4 and/or other desired operations. The logic gate circuitry 708 shown in FIG. 7 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations/functions. The logic gate circuitry 708 may include other electrical structures such as look-up tables (LUTs), registers (e.g., flip-flops or latches), multiplexers, etc.

The configurable interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example dedicated operations circuitry 714. In this example, the dedicated operations circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the programmable circuitry 512 of FIG. 5, many other approaches are contemplated. For example, FPGA circuitry may include an on-board CPU, such as one or more of the example CPU 720 of FIG. 6. Therefore, the programmable circuitry 512 of FIG. 5 may additionally be implemented by combining at least the example microprocessor 600 of FIG. 6 and the example FPGA circuitry 700 of FIG. 7. In some such hybrid examples, one or more cores 602 of FIG. 6 may execute a first portion of the machine readable instructions represented by the flowchart(s) of FIGS. 3 and 4 to perform first operation(s)/function(s), the FPGA circuitry 700 of FIG. 7 may be configured and/or structured to perform second operation(s)/function(s) corresponding to a second portion of the machine readable instructions represented by the flowcharts of FIGS. 3 and 4, and/or an ASIC may be configured and/or structured to perform third operation(s)/function(s) corresponding to a third portion of the machine readable instructions represented by the flowcharts of FIGS. 3 and 4.

It should be understood that some or all of the circuitry of FIG. 2 may, thus, be instantiated at the same or different times. For example, same and/or different portion(s) of the microprocessor 600 of FIG. 6 may be programmed to execute portion(s) of machine-readable instructions at the same and/or different times. In some examples, same and/or different portion(s) of the FPGA circuitry 700 of FIG. 7 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 600 of FIG. 6 may execute machine readable instructions in one or more threads executing concurrently and/or in series. In some examples, the FPGA circuitry 700 of FIG. 7 may be configured and/or structured to carry out operations/functions concurrently and/or in series. Moreover, in some examples, some or all of the circuitry of FIG. 2 may be implemented within one or more virtual machines and/or containers executing on the microprocessor 600 of FIG. 6.

In some examples, the programmable circuitry 512 of FIG. 5 may be in one or more packages. For example, the microprocessor 600 of FIG. 6 and/or the FPGA circuitry 700 of FIG. 7 may be in one or more packages. In some examples, an XPU may be implemented by the programmable circuitry 512 of FIG. 5, which may be in one or more packages. For example, the XPU may include a CPU (e.g., the microprocessor 600 of FIG. 6, the CPU 720 of FIG. 7, etc.) in one package, a DSP (e.g., the DSP 722 of FIG. 7) in another package, a GPU in yet another package, and an FPGA (e.g., the FPGA circuitry 700 of FIG. 7) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to enable effective indication of messages for fraud prevention are disclosed herein. Further examples and combinations thereof include the following:

Example 1 includes an apparatus comprising machine readable instructions, and at least one processor circuit to be programmed by the machine readable instructions to classify, with a trained machine-learning model, messages of a messaging platform of a computing device as one of a financial transaction or a non-financial transaction, and provide a warning based on a one-time password (OTP) message of the messages being classified as a financial transaction.

Example 2 includes the apparatus as defined in example 1, wherein one or more of the at least one processor circuit is to label the OTP message as the financial transaction or the non-financial transaction.

Example 3 includes the apparatus as defined in example 1, wherein one or more of the at least one processor circuit is to flag the OTP message based on the classification.

Example 4 includes the apparatus as defined in example 1, wherein one or more of the at least one processor circuit is to provide a banner indication at the computing device corresponding to the OTP message.

Example 5 includes the apparatus as defined in example 1, wherein one or more of the at least one processor circuit is to determine a first parameter adjustment of the machine-learning model at the computing device and provide the first parameter adjustment to a data collector to adjust the machine-learning model.

Example 6 includes the apparatus as defined in example 5, wherein the first parameter adjustment is to be aggregated with a second parameter adjustment of the machine-learning model from a second computing device for adjustment of the machine-learning model.

Example 7 includes the apparatus as defined in example 1, wherein one or more of the at least one processor circuit is to classify the messages being related to a bank transaction approval or not being related to a bank transaction approval.

Example 8 includes a portable device comprising network interface circuitry to receive a message, and a display to display a warning that indicates that the message includes a one-time password (OTP) associated with a financial transaction, the message classified with a trained machine-learning model.

Example 9 includes the portable device as defined in example 8, further including at least one processor circuit to classify the messages as associated with one of a financial transaction or a non-financial transaction.

Example 10 includes the portable device as defined in example 9, wherein one or more of the at least one processor circuit is to at least one of (i) flag the message or (ii) cause the display to show a banner indication based on the classification.

Example 11 includes the portable device as defined in example 10, wherein one or more of the at least one processor circuit is to determine a first parameter adjustment of the machine-learning model at the portable device and provide the first parameter adjustment to a data collector to adjust the machine.

Example 12 includes the portable device as defined in example 10, wherein one or more of the at least one processor circuit is to classify the messages being related to a bank transaction approval or not being related to a bank transaction approval.

Example 13 includes the portable device as defined in example 8, wherein the receiver is to receive an indication that the message is classified as a financial transaction.

Example 14 includes a non-transitory machine readable storage medium comprising instructions to cause at least one processor circuit to at least classify, with a trained machine-learning model, messages of a messaging platform of a computing device as one of a financial transaction or a non-financial transaction, and provide a warning based on a one-time password (OTP) message of the messages being classified as a financial transaction.

Example 15 includes the non-transitory machine readable storage medium as defined in example 14, wherein the instructions cause one or more of the at least one processor circuit to label the OTP message as the financial transaction or the non-financial transaction.

Example 16 includes the non-transitory machine readable storage medium as defined in example 14, wherein the instructions cause one or more of the at least one processor circuit to flag the OTP message based on the classification.

Example 17 includes the non-transitory machine readable storage medium as defined in example 14, wherein the instructions cause one or more of the at least one processor circuit to provide a banner indication at the computing device corresponding to the OTP message.

Example 18 includes the non-transitory machine readable storage medium as defined in example 14, wherein the instructions cause one or more of the at least one processor circuit to determine a first parameter adjustment of the machine-learning model at the computing device and provide the first parameter adjustment to a data collector to adjust the machine-learning model.

Example 19 includes the non-transitory machine readable storage medium as defined in example 18, wherein the instructions cause the first parameter adjustment is to be aggregated with a second parameter adjustment of the machine-learning model from a second computing device for adjustment of the machine-learning model.

Example 20 includes the non-transitory machine readable storage medium as defined in example 14, wherein the instructions cause one or more of the at least one processor circuit to classify the messages as a bank transaction approval or not a bank transaction approval.

From the foregoing, it will be appreciated that example systems, apparatus, articles of manufacture, and methods have been disclosed that enable effective indications that can thwart fraud attempts on unsuspecting consumers. Examples disclosed herein leverage AI/ML to flag and/or identify messages that could be overlooked as financial transactions.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one computer-readable medium having stored thereon instructions which, when executed, cause a computing device to perform operations comprising:
detecting, in real time, a message having a scam message being received at the computing device, wherein the computing device comprises a mobile computing device,
wherein, based on a localized machine learning model, the message is analyzed to include the scam message,
wherein analyzing the message based on the localized machine learning model is further based on a natural language processing (NLP) transformer model for processing textual contents of the message; and
issuing a warning regarding the message having the scam message.

2. The computer-readable medium of claim 1, wherein, based on the localized machine learning model and while protecting private user data, the warning is issued for the scam message when the message includes a request for a one-time password (OTP).

3. The computer-readable medium of claim 1, wherein the localized machine learning model is fine-tuned based on a federated learning model, while private user data remains secured.

4. A method comprising:
detecting, in real time, a message having a scam message being received at a computing device, wherein the computing device comprises a mobile computing device,
wherein, based on a localized machine learning model, the message is analyzed to include the scam message,
wherein analyzing the message based on the localized machine learning model is further based on a natural language processing (NLP) transformer model for processing textual contents of the message; and
issuing a warning regarding the message having the scam message.

5. The method of claim 4, wherein, based on the localized machine learning model and while protecting private user data, the warning is issued for the scam message when the message includes a request for a one-time password (OTP).

6. The method of claim 4, wherein the localized machine learning model is fine-tuned based on a federated learning model, while private user data remains secured.

7. An apparatus comprising:
processing circuitry to:
detect, in real time, a message having a scam message being received by the processing circuitry of a computing device having a mobile computing device,
wherein, based on a localized machine learning model, the message is analyzed to include the scam message,
wherein analyzing the message based on the localized machine learning model is further based on a natural language processing (NLP) transformer model for processing textual contents of the message; and
issuing a warning regarding the message having the scam message.

8. The apparatus of claim 7, wherein, based on the localized machine learning model and while protecting private user data, the warning is issued for the scam message when the message includes a request for a one-time password (OTP).

9. The apparatus of claim 7, wherein the localized machine learning model is fine-tuned based on a federated learning model, while private user data remains secured.
